(19) United States
(12) Patent Application Publication
(10) Pub. No.: US 2024/0230355 A9
(43) Pub. Date: Jul. 11, 2024

(54) METHOD AND SYSTEM FOR SELECTIVELY INITIATING ACTIONS IN ACCORDANCE WITH A DRIVER RISK ANALYSIS

(71) Applicant: Zendrive, Inc., San Francisco, CA (US)

(72) Inventors: Gerry Goldstein, San Francisco, CA (US); Manish Kumar, San Francisco, CA (US); Prateek Gupta, San Francisco, CA (US); Christopher Damon, San Francisco, CA (US); Jayanta Kumar Pal, San Francisco, CA (US); Mustansir Mama, San Francisco, CA (US); Nitin Dileep Salodkar, San Francisco, CA (US); Shivam Singh, San Francisco, CA (US)

(21) Appl. No.: 18/379,495

(22) Filed: Oct. 12, 2023

Related U.S. Application Data
(60) Provisional application No. 63/417,470, filed on Oct. 19, 2022.

(51) Int. Cl. G01C 21/34

(52) U.S. Cl. CPC G01C 21/3484; G01C 21/3438

(57) ABSTRACT

A system for driver risk analysis includes and/or interfaces with: a processing subsystem, a set of sensors, and a set of models and/or algorithms. Additionally or alternatively, the system can include and/or interface with any or all of: a software platform, a set of client applications, a set of user devices, and/or any other components. A method for driver risk analysis can include any or all of: collecting a set of data; analyzing the set of data to determine a set of features; analyzing the set of data to produce a set of driver risk outputs; and triggering a set of actions based on the set of driver risk outputs. Additionally or alternatively, the method can include any or all of: determining eligibility criteria associated with a set of end entities; modifying any or all of the collection of data and/or the analysis of data and/or the driver risk outputs based on the eligibility criteria; training and/or updating a set of models and/or algorithms; and/or any other processes.

### CROSS-REFERENCE TO RELATED APPLICATIONS

This application claims the benefit of U.S. Provisional Application No. 63/417,470, filed 19 Oct. 2022, which is incorporated in its entirety by this reference.

### TECHNICAL FIELD

This invention relates generally to the telematics and vehicular activity monitoring fields, and more specifically to a new and useful system and method for selectively initiating actions in accordance with a driver risk analysis in the telematics and vehicular activity monitoring fields.

### BRIEF DESCRIPTION OF THE FIGURES

FIG. 1 is a schematic of a system for selectively initiating actions in accordance with a driving performance analysis.

FIG. 2 is a schematic of a method for selectively initiating actions in accordance with a driving performance analysis.

FIG. 3 depicts a variant of a processing workflow of a set of models and/or algorithms for determining a driving performance analysis.

FIG. 4 depicts a variant of utilizing subgroup assignment to a user to inform future processing.

FIGS. 5A-5C depict a variant of selective communication between entities through a set of applications executable on a mobile user device.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

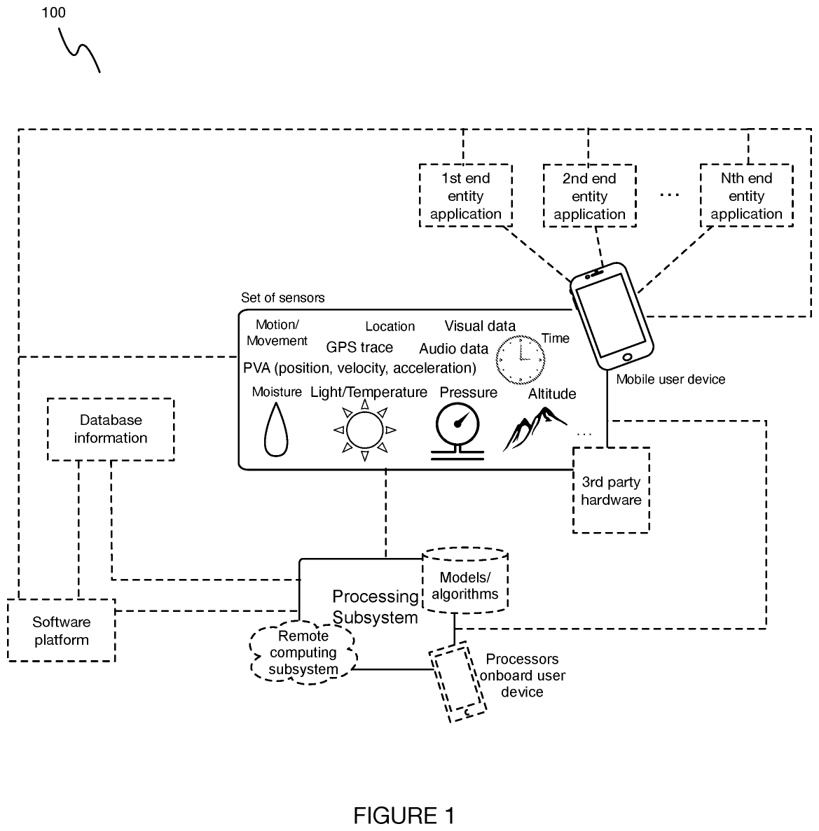

As shown in FIG. 1, a system 100 for driver risk analysis includes and/or interfaces with: a processing subsystem, a set of sensors, and a set of models and/or algorithms. Additionally or alternatively, a system 100 for driver risk analysis can include and/or interface with any or all of: a software platform, a set of client applications, a set of user devices, and/or any other components. Further additionally or alternatively, the system can include and/or interface with any or all of the components as described in any or all of: U.S. application Ser. No. 15/243,565, filed 22 Aug. 2016, now issued as U.S. Pat. No. 9,818,239; U.S. application Ser. No. 15/835,284, filed 7 Dec. 2017, now issued as U.S. Pat. No. 10,012,993; U.S. application Ser. No. 16/022,120, filed 28 Jun. 2018, now issued as U.S. Pat. No. 11,151,813; U.S. application Ser. No. 16/022,184, filed 28 Jun. 2018, now issued as U.S. Pat. No. 10,304,329; U.S. application Ser. No. 16/201,955, filed 27 Nov. 2018, now issued as U.S. Pat. No. 10,278,039; U.S. application Ser. No. 17/155,939, filed 22 Jan. 2021, now issued as U.S. Pat. No. 10,997,800; U.S. application Ser. No. 17/111,299, filed 3 Dec. 2020, now issued as U.S. Pat. No. 11,175,152; U.S. application Ser. No. 16/700,991, filed 2 Dec. 2019; U.S. application Ser. No. 17/831,731, filed 3 Jun. 2022; U.S. application Ser. No. 17/959,067, filed 3 Oct. 2022; U.S. application Ser. No. 18/074,859, filed 5 Dec. 2022; U.S. application Ser. No. 18/073,959, filed 2 Dec. 2022; and U.S. application Ser. No. 18/115,626, filed 28 Feb. 2023; each of which is incorporated in its entirety by this reference.

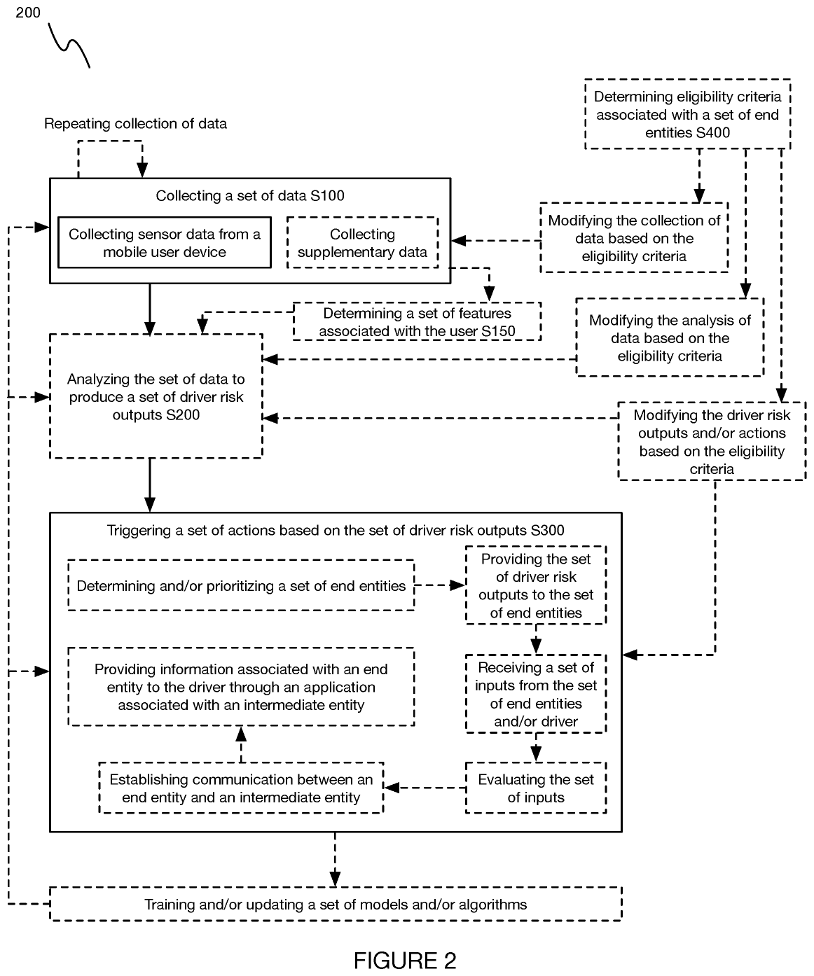

As shown in FIG. 2, a method 200 for driver risk analysis includes collecting a set of data S100; analyzing the set of data to determine a set of features S150; analyzing the set of data to produce a set of driver risk outputs S200; and triggering a set of actions based on the set of driver risk outputs S300. Additionally or alternatively, the method 200 can include any or all of: determining eligibility criteria associated with a set of end entities S400; modifying any or all of the collection of data and/or the analysis of data and/or the driver risk outputs based on the eligibility criteria; training and/or updating a set of models and/or algorithms; and/or any other processes. Further additionally or alternatively, the method 200 can include any or all of: U.S. application Ser. No. 15/243,565, filed 22 Aug. 2016, now issued as U.S. Pat. No. 9,818,239; U.S. application Ser. No. 15/835,284, filed 7 Dec. 2017, now issued as U.S. Pat. No. 10,012,993; U.S. application Ser. No. 16/022,120, filed 28 Jun. 2018, now issued as U.S. Pat. No. 11,151,813; U.S. application Ser. No. 16/022,184, filed 28 Jun. 2018, now issued as U.S. Pat. No. 10,304,329; U.S. application Ser. No. 16/201,955, filed 27 Nov. 2018, now issued as U.S. Pat. No. 10,278,039; U.S. application Ser. No. 17/155,939, filed 22 Jan. 2021, now issued as U.S. Pat. No. 10,997,800; U.S. application Ser. No. 17/111,299, filed 3 Dec. 2020, now issued as U.S. Pat. No. 11,175,152; U.S. application Ser. No. 16/700,991, filed 2 Dec. 2019; U.S. application Ser. No. 17/831,731, filed 3 Jun. 2022; U.S. application Ser. No. 17/959,067, filed 3 Oct. 2022; U.S. application Ser. No. 18/074,859, filed 5 Dec. 2022; U.S. application Ser. No. 18/073,959, filed 2 Dec. 2022; and U.S. application Ser. No. 18/115,626, filed 28 Feb. 2023; each of which is incorporated in its entirety by this reference, or any other suitable processes performed in any suitable order.

The method 200 can be performed with a system as described above and/or any other suitable system.

### 2. Benefits

The system and method for driver risk analysis can confer several benefits over current systems and methods.

In a first variation, the technology confers the benefit of producing an optimized, at least partially automated matching between a driver (via their mobile user device) and a service provider entity (e.g., insurer, vehicle insurer, vehicle maintenance provider, etc.) based on features associated with the driver's driving behavior (e.g., driving performance, safe driving habits, risky driving behaviors, etc.). Additionally or alternatively, the technology can confer the benefit of enabling an optimized, at least partially automated determination and provision of information (e.g., an offer in the form of an advertisement, a graphical interface that the driver can engage with, an alert or message, etc.) from the service provider entity to the driver (via one or more applications executing on the mobile user device) based on his or her particular driving behavior.

In a set of preferred examples, for instance, the technology enables a driver to be automatically matched with one or more insurance providers and/or associated insurance plan offers based on his or driving behavior, such that the best drivers can be maximally rewarded for their specific driving behavior. Additionally or alternatively, the technology can further enable insurance providers to efficiently recruit and secure the best drivers, inform drivers of ways to improve their driving behavior, and/or enable any other outcomes.

In an alternative set of examples, other information can be selectively provided to a driver based on his or her driving behavior, such as, but not limited to: driving data and/or analytics (e.g., selectively provided to drivers with a riskiness above a predetermined threshold to prevent notification fatigue, etc.), recommendations (e.g., for vehicle maintenance based on which vehicle maintenance providers are a best match for the driver, etc.), and/or any other information.

Additionally, the technology can further confer the benefit of enabling the matching between the driver and the service provider entity and/or the matching of the driver with an offer from the service provider entity and/or the provision of information to the driver to be performed with a minimal amount of data and/or within a minimal amount of time, which can further function to: prevent drivers from losing interest in participating in the matching process; maximize the number of drivers that engage with the service provider entity and/or offer; and/or confer any other benefits.

In examples, this efficiency benefit is enabled through the training and usage of models and/or algorithms that are designed to robustly, repeatedly, and reliably distinguish between risky and safe driving behaviors, such as through any or all of: the collection of data from an expansive collection of drivers at their personal user devices over a large variety of regions, driving conditions, and other environments; the development of sophisticated (e.g., highly tuned) machine learning algorithms; the ability to re-train and/or adjust and/or tailor any or all of the models to particular driver features and/or driving conditions; and/or any other features.

In a second variation, additional or alternative to the above, the technology can confer the benefit of building and executing a privacy-protective way for consumers to share mobility data from their personal user devices in order to get more accurate assessments (e.g., in auto insurance or other offers) and/or information, which can confer benefits to the consumers without sacrificing their privacy or data. This can subsequently promote fairness through the elimination of dependencies on traditional rating factors for drivers, which are conventionally discriminatory (e.g., based on credit score, sex, age, etc.) and not directly related to (e.g., not directly correlated with) collision risk.

In a third variation, additional or alternative to those above, the technology confers the benefit of dynamically adjusting how data gets processed (e.g., which models are utilized, how the data is formatted, etc.) during the method, through the iterative (e.g., continuous, at a predetermined frequency, at multiple times during the method, etc.) prediction of a set of metrics and/or the comparison of collected data (or metrics determined based on the data) with a set of thresholds and/or satisfaction criteria. For instance, a user can be preliminarily assigned to have their driving data and/or driving risk score processed by and/or sent to a particular end entity, where this assignment is iteratively checked and optionally refined if it is determined, for instance, that: the user's data will not meet a set of eligibility criteria associated with the current assigned end entity, that the user will meet a set of eligibility criteria associated with a different end entity, that the user will not qualify for and/or engage with information (e.g., an insurance plan, a maintenance package, etc.) from the current entity, that the user will qualify for and/or engage with information (e.g., an insurance plan, a maintenance package, etc.) from a different entity, and/or any other outcomes can be determined or predicted and utilized. This can enable, for instance, a most optimized matching between the user and end entity to occur, a most efficient performance of the method to occur, and/or any other outcomes.

Additionally or alternatively, the system and method can confer any other benefits.

### 3. System 100

As shown in FIG. 1, a system 100 for selectively initiating actions in accordance with a driver risk analysis includes and/or interfaces with: a processing subsystem, a set of sensors, and a set of models and/or algorithms. Additionally or alternatively, a system 100 for driver risk analysis can include and/or interface with any or all of: a software platform, a set of client applications, a set of user devices (e.g., mobile user devices), and/or any other components.

The system preferably functions to enable the determination and triggering of actions associated with a driver based on driving insights derived from the processing of sensor data. In specific examples, the sensor data is collected partially or exclusively from sensors onboard a personal mobile user device associated with the user, which can function to enable significant amounts of data to be easily, efficiently, and continuously collected from a multitude of drivers in various regions, thereby configuring robust models to be trained and implemented in the processing of data. Additionally or alternatively, any other sensor data and/or supplementary data can be collected and/or utilized by the system.

Additionally or alternatively, the system can function to optimize the matching of a driver with a service provider (e.g., to increase driver satisfaction with the service provider, decrease costs for services provided to safe drivers, increase costs for services provided to unsafe drivers thereby encouraging them to drive safer, etc.), optimize and/or differentiate between the drivers applying for services, decrease a time and/or amount of data required to provide an offer to a driver, and/or can perform any other functions.

The system 100 preferably includes and/or interfaces with a set of sensors (equivalently referred to herein as a sensor system and/or sensor subsystem), wherein the sensors function to collect vehicular monitoring data with which to assess the driving behavior of a driver. Additionally or alternatively, the set of sensors can perform any other suitable functions.

The sensors are preferably located onboard a user device (e.g., mobile user device) associated with the driver, but can additionally or alternatively be offboard a user device and/or at any other locations (e.g., part of an OBD port and/or 3^{rd} party device, onboard the vehicle, in an environment of the vehicle, etc.). Examples of the user device include a tablet, smartphone, mobile phone, laptop, watch, wearable device (e.g., glasses), or any other suitable user device. The user device can include power storage (e.g., a battery), processing systems (e.g., CPU, GPU, memory, etc.), user outputs (e.g., display, speaker, vibration mechanism, etc.), user inputs (e.g., a keyboard, touchscreen, microphone, etc.), a location system (e.g., a GPS system), sensors (e.g., optical sensors, such as light sensors and cameras, orientation sensors, such as accelerometers, gyroscopes, and altimeters, audio sensors, such as microphones, magnetometers, microphones for detecting collision-related sounds, etc.), data communication system (e.g., a WiFi transceiver(s), Bluetooth transceiver(s), cellular transceiver(s), etc.), or any other suitable component.

The sensors can include any or all of: audio sensors (e.g., microphones), motion sensors (e.g., accelerometer, gyroscope, magnetometer, orientation sensor, etc.), which can function to detect any or all of: user device movement (e.g., acceleration, speed, etc.), user device orientation, vehicle movement, vehicle orientation, position of user device within the vehicle, and/or any other suitable information; proximity sensors (e.g., optical sensors, capacitive sensors, etc.), which can function to detect and/or classify a user's handling of a user device; location sensors (e.g., GPS); any or all of the sensors described above; any or all of the sensors described below; and/or any other suitable sensors.

Examples of sensors from which data can be collected are described in any or all of: U.S. application Ser. No. 15/243,565, filed 22 Aug. 2016, now issued as U.S. Pat. No. 9,818,239; U.S. application Ser. No. 15/835,284, filed 7 Dec. 2017, now issued as U.S. Pat. No. 10,012,993; U.S. application Ser. No. 16/022,120, filed 28 Jun. 2018, now issued as U.S. Pat. No. 11,151,813; U.S. application Ser. No. 16/022,184, filed 28 Jun. 2018, now issued as U.S. Pat. No. 10,304,329; U.S. application Ser. No. 16/201,955, filed 27 Nov. 2018, now issued as U.S. Pat. No. 10,278,039; U.S. application Ser. No. 17/155,939, filed 22 Jan. 2021, now issued as U.S. Pat. No. 10,997,800; U.S. application Ser. No. 17/111,299, filed 3 Dec. 2020, now issued as U.S. Pat. No. 11,175,152; U.S. application Ser. No. 16/700,991, filed 2 Dec. 2019; U.S. application Ser. No. 17/831,731, filed 3 Jun. 2022; U.S. application Ser. No. 17/959,067, filed 3 Oct. 2022; U.S. application Ser. No. 18/074,859, filed 5 Dec. 2022; U.S. application Ser. No. 18/073,959, filed 2 Dec. 2022; and U.S. application Ser. No. 18/115,626, filed 28 Feb. 2023; each of which is incorporated in its entirety by this reference.

The system 100 further preferably includes and/or interfaces with a set of one or more computing and/or processing subsystems (e.g., computers, processors, microprocessors, CPUs, GPUs, etc.), which can individually and/or collectively function to perform any or all of the processing in the method 200. In preferred variations, the processing of the method 200 is at least partially performed at a processing subsystem onboard the user device, which can function to preserve privacy of the user. Additionally or alternatively, any or all of the processing can be performed at a remote processing subsystem (e.g., cloud-based processing subsystem) and/or any combination of processing subsystems. In some embodiments of the system, for instance, each user can opt in (e.g., through an intermediate entity application, through an end entity application, etc.) to data (e.g., telematic data used to assess driving performance) being collected at his or her user device (e.g., mobile user device, smartphone, etc.) in order to provide a privacy-centric, transparent user experience regarding collection of his or her data. In additional or alternative embodiments, the system and/or method can be configured such that data is only shared anonymously for the purpose of determining offer eligibility (e.g., according to a set of eligibility criteria as described below) once sufficient data is collected.

The computing and/or processing subsystems are preferably (e.g., individually, collectively, etc.) configured to evaluate a set of models and/or algorithms utilized in the method 200. The set of models and/or algorithms preferably at least partially include machine learning (e.g., trained, deep learning, neural networks, etc.) models and/or algorithms, but can additionally or alternatively include any or all of: rule-based and/or programmed models and/or algorithms (e.g., rule-based logic), statistical models, decision trees, lookup tables, and/or any other tools utilized in the method 200.

The set of models and/or algorithms preferably includes a set of one or more driver risk analysis (equivalently referred to herein as driver risk) models, which function to assess a riskiness associated with how the user drives (or alternatively, how safely the user drives). Additionally or alternatively, the driver risk model(s) can assess any number of driving parameters and/or features additional or alternative to riskiness (e.g., caution, traffic rule compliance, aggression, friendliness to other drivers on the road, etc.).

The set of driver risk models preferably receives sensor data (e.g., as described above) as inputs, but can additionally or alternatively include supplementary information (e.g., associated with the driver; associated with the driver's environment such as traffic conditions, weather conditions, etc.; etc.), 3^{rd} party data, and/or any other information.

In a preferred set of variations, the set of driver risk models can include and/or interface with any or all of the models as described in any or all of: U.S. application Ser. No. 15/243,565, filed 22 Aug. 2016; U.S. application Ser. No. 15/835,284, filed 7 Dec. 2017; U.S. application Ser. No. 16/022,120, filed 28 Jun. 2018; U.S. application Ser. No. 16/201,955, filed 27 Nov. 2018; U.S. application Ser. No. 17/111,299, filed 3 Dec. 2020; U.S. application Ser. No. 16/700,991, filed 2 Dec. 2019; and U.S. application Ser. No. 17/831,731, filed 3 Jun. 2022; and/or any or all of those described above; each of which is incorporated herein in its entirety by this reference.

The driver risk model(s) preferably function to detect, determine, and/or characterize the occurrence of events and/or behavior which indicate risky driving, such as, but not limited to: aggressive acceleration, hard braking, phone usage, speeding and/or over-speeding, hard turns, road rage, and/or any other events.

Additionally or alternatively, the driver risk model(s) can detect, determine, and/or characterize supplementary driver behaviors and/or patterns, such as, but not limited to: driving during night hours, driving on particular road types (e.g., highway, residential, country roads, etc.), driving during dangerous weather conditions (e.g., snow, rain, sleet, etc.), driving during high traffic conditions, driving along risky roads and/or risky regions (e.g., as described in U.S. application Ser. No. 17/111,299, filed 3 Dec. 2020) such as frequently (e.g., as a primary route, as a most frequently set of routes, as a route traveled every day and/or every week, etc.) traveled routes composed of route segments having individual and/or aggregated risk value(s) above a predetermined threshold, being characterized as a low mileage driver (e.g., driving less on average than a predetermined number of miles in a particular duration of time [e.g., week, month, day, etc.], driving trips that are each on average of less than a predetermined number of miles, driving less than a predetermined number of days per week, etc.), being a rideshare driver (e.g., through detection of a rideshare application on the user's mobile device, through input received from the user, from detection of various other devices traveling with the user's device during his or her trips [e.g., detecting a different user device traveling with the driver's mobile device during at least a predetermined percentage of detected trips], etc.), and/or any other behaviors/patterns. In some examples, these supplementary driver behaviors can be determined as driver features (e.g., for segmentation, for funneling of data to specific models, etc.) in S150.

The driver risk model(s) can optionally aggregate any or all of these outputs, such as to: determine an overall risk score associated with the driver (e.g., based on aggregation of scores for individual events, based on combining multiple scores in a weighted fashion, based on aggregating risk scores over time, etc.); determine compounded driving behaviors associated with the driver (e.g., does the driver take part in risky driving events while there are other vehicles around and/or during dangerous conditions); and/or any other outputs can be determined.

In some variations, for instance, the method calculates a driver score that can be stored, adapted, and/or shared in response to receiving user consent to sharing data with participating end entities (e.g., insurers), putting the user in control of their driving data and scores to maximize savings benefits across carriers. Additionally or alternatively, any or all of the end entities can be fixed, dynamically and/or automatically determined (e.g., with a set of algorithms or models), and/or otherwise suitably determined.

Additionally or alternatively, the method calculates a driver score that can be stored, adapted, and/or shared in response to receiving user consent to sharing data with participating end entities (e.g., insurers) via an intermediate entity.

Additionally or alternatively, the driver risk model(s) can function to (and/or interface with models which function to) detect and/or determine if the driver is actually driving (e.g., not a passenger, not taking commuter transit, etc.), what type of vehicle the driver is driving (e.g., automobile, motorcycle, scooter, etc.), and/or any other features can be determined.

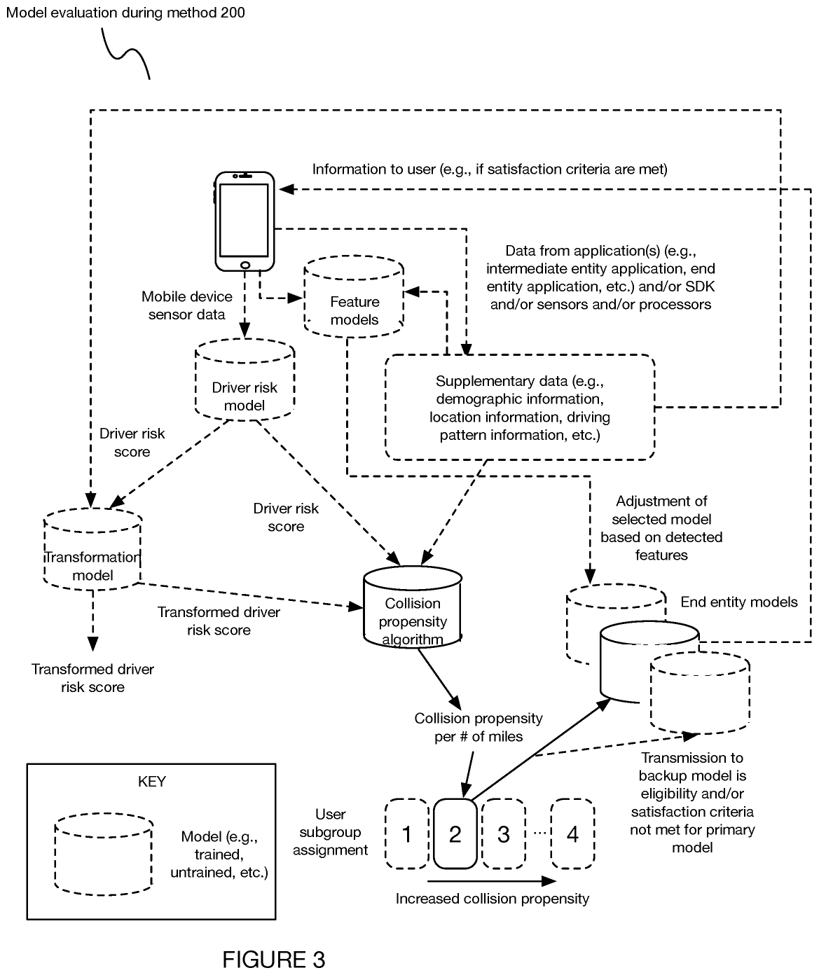

The set of models and/or algorithms preferably includes a collision propensity model and/or algorithm (equivalently referred to herein as a collision propensity model) (e.g., as shown in FIG. 3), which functions to predict the driver's propensity for collision (and/or actually collision participation). This can be determined based on any or all of: raw sensor data, supplementary data, any or all of the outputs of a set of driver risk model(s), and/or any other information.

The collision propensity model (and/or the risk model) can be any or all of: executed with processors onboard the user device, executed at a remote computing and/or processing subsystem, executed at processors associated with an end entity (e.g., cloud computing system in communication with an end entity application, user device processors, etc.), executed at processors associated with an intermediate entity (e.g., cloud computing system in communication with an intermediate entity application, user device processors, etc.), and/or executed with any other suitable processors.

In one set of variants, the collision propensity model is a mathematical model, and preferably a statistical model (e.g., generalized linear model [GLM], Poisson model, etc.). Additionally or alternatively, any or all of the functionality of these models and/or algorithms can be implemented with a machine learning model and/or algorithm, integrated with the risk model(s) in a combined model, and/or can be otherwise suitably implemented.

The collision propensity model preferably receives as input one or more outputs of the set of risk model(s), and optionally a transformed and/or otherwise processed version of the outputs of the risk model(s), and/or any other inputs (e.g., supplementary data).

In some variations, for instance, any or all outputs (e.g., intermediate outputs such as a driving events, final outputs such as overall risk score(s), etc.) of the risk models are transformed (e.g., scaled, adjusted, aggregated, aggregated in a weighted fashion, etc.) prior to evaluation with the collision propensity model. This can function to take into account features of the driver being evaluated (e.g., age, sex, etc.), the region in which the driver is driving (e.g., to take into account the aggressiveness and risk of certain areas over others), and/or any other features, thereby customizing the risk model and/or its outputs based on various populations that the model(s) can be applied to. Additionally or alternatively, the data used to train the risk model(s) can be transformed as described and/or in any other ways, the outputs of the collision propensity model can be transformed, and/or any other data adjustments can be made.

In a set of examples, a trained model (e.g., machine learning model, deep learning model, set of neural networks, etc.) is initially used to determine a driver risk score and/or associated set of metrics (e.g., metric quantifying the frequency that the user participates in aggressive driving, metric quantifying how many hard turns the user drivers, metric quantifying how much the user drives over the speed limit, etc.), where this score and/or metrics serves as an input to a statistical collision propensity model.

In another set of variants, the collision propensity model is a trained model. In examples, the collision propensity model receives raw sensor data as input. In additional or alternative examples, the collision propensity model receives a risk score (e.g., from a trained risk model, from a statistical risk model, etc.) as input. Additionally or alternatively, the collision propensity model can receive intermediate features as input and/or any other information.

The collision propensity model preferably produces as output an expected collision risk for the driver (equivalently referred to herein as a predicted collision risk) based on his or her driving behavior within a certain time period (e.g., predetermined time period, predetermined “test drive” period as described below, etc.). The expected collision risk can optionally further incorporate a distance and/or duration of time for which the expected collision risk applies to, such as: an expected collision risk per predetermined number of miles (e.g., 1 million miles, 100 thousand miles, 10 thousand miles, 5 thousand miles, 1 thousand miles, 500 miles, 100 miles, between 100 and 1 million miles, etc.); an expected collision risk per predetermined duration of time (e.g., 1 year, 5 years, 10 years, between 1 year and 10 years, duration of time which the offer applies to, etc.); and/or any other predicted values.

In a preferred set of variations, for instance, the collision propensity model comprises a statistical model (e.g., Poisson regression model) which produces an expected collision risk per predetermined number of miles for each driver based on outputs of the set of risk model(s). Additionally or alternatively, the collision propensity model can include one or more machine learning models, a combination of models, and/or any other models.

The outputs of the collision propensity model preferably further function to enable comparisons among multiple drivers, such as an organization, sorting, and/or assignment of the drivers into driving performance groups relative to other drivers. In preferred variations, for instance, the collision propensity model and/or the combination of the collision propensity model with the risk model(s) is configured to provide significant discriminatory power between drivers, such as through an at least minimum value of lift (e.g., decile lift) between groups of drivers. This value of lift can be any or all of: predetermined, set (e.g., based on inputs and/or requirements from a set of end entities as described below), dynamically determined, and/or otherwise determined.

In a set of examples, for instance, the driver can be assigned to a group of drivers (e.g., 1 of 10 groups of increasing estimated risk) based on his or her collision propensity value, such that the most unsafe group has a predetermined higher collision frequency (e.g., lox higher collision frequency) as compared to the safest group.

Additionally or alternatively, the collision propensity model and/or set of models can be otherwise suitably implemented.

Further additionally or alternatively, the method (e.g., as described below) can be configured to transmit sensor data (e.g., raw sensor data, formatted sensor data, etc.) to end entities, wherein the end entities execute their own models and/or algorithms for determining whether or not information should be provided to the user (e.g., via an intermediate entity application, via an end entity application, etc.) and/or any other actions should be triggered.

Additionally or alternatively, the system 100 can include and/or interface with any other components and/or combination of components, such as, but not limited to, any or all of: a set of applications executing on the user device (e.g., intermediate entity applications, end entity applications, etc.), a software platform (e.g., software development kit [SDK] platform) operable to interface with the set of sensors and/or applications executing on a user device, set of application programming interfaces (APIs) in communication with intermediate applications and/or end applications, and/or any other components.

In a preferred set of variations, for instance, the system includes a software platform (e.g., SDK) including and/or in communication with the processing subsystem, wherein the software platform (e.g., directly, through the processing subsystem, etc.) interfaces with at least a set of intermediate entity applications (e.g., as described below) executing on a set of user devices, and optionally with a set of end entity applications (e.g., as described below), and/or any other applications.

### 4. Method 200

As shown in FIG. 2, a method 200 for driver risk analysis includes collecting a set of data S100; analyzing the set of data to determine a set of features S150; analyzing the set of data to produce a set of driver risk outputs S200; and triggering a set of actions based on the set of driver risk outputs S300. Additionally or alternatively, the method 200 can include any or all of: determining and/or checking for satisfaction of eligibility criteria associated with a set of end entities S400; modifying any or all of the collection of data and/or the analysis of data and/or the driver risk outputs based on the eligibility criteria; training and/or updating a set of models and/or algorithms; and/or any other processes.

The method 200 can be performed with a system 100 as described above and/or any other suitable system.

The method 200 preferably functions to enable actionable insights to be derived and corresponding actions triggered in response to determining the risk (or other driving behaviors) associated with a driver. In preferred variations of the method, any or all of these determinations are made automatically or partially automatically, which can function to increase the efficiency (e.g., speed) with which these determinations are made and/or implemented. Additionally or alternatively, the method 200 can function to reduce and/or eliminate human input required for any or all of these determinations, increase an accuracy and/or significance associated with any or all of these determinations, and/or can perform any other suitable functions.

In a set of preferred implementations of the method 200, the method 200 functions to enable optimized, at least partially automated matches to be made between drivers and end entities (e.g., insurance providers, vehicle maintenance providers, etc.), such that, for instance, any or all of the following actions can be triggered (e.g., automatically triggered) in response: the generation of a custom offer (e.g., insurance offer, maintenance offer, etc.) for that driver, the transmission of the custom offer to the driver (e.g., through an application associated with an intermediate entity separate and distinct from the end entity, through an application associated with the end entity, etc.), a verification that the driver is eligible for an offer, a prioritization of offers such that the driver is provided with the best offers and/or an ordered set of offers, and prioritization of drivers for the end entity to engage with, and/or any other actions.

In examples of these implementations, the system and method can optionally be configured to interface with a set of entities (equivalently referred to herein as 3^{rd} parties and/or providers) and/or their associated systems/components, such as applications (e.g., client applications executing on user devices) provided by the entities, APIs associated with the applications, processing subsystems and/or stored information (e.g., databases with eligibility criteria), and/or any other components.

In a set of examples, for instance, the method 200 is configured to interface with a set of multiple end entities along with a set of one or more intermediate entities, wherein the intermediate entities function to enable the end entities to interface with the drivers. Additionally, the intermediate entities can function to enable data collection and/or data collection permissions to take place in S100, facilitate the transmission of data to end entities, facilitate (e.g., enable, initiate, etc.) the provision of information (e.g., offers, links, particular graphical user interfaces displayed at a display of the user device, etc.) to drivers and/or the guiding to drivers to view offers or additional information at end entity applications and/or websites, and/or the intermediate entities can enable any other benefits or functions.

In a set of specific examples, for instance, the initiation of a period defined by a predetermined period of time and/or other requirements/eligibility criteria (e.g., number of miles, number of trips, number of days that user drives, etc.)— equivalently referred to herein as a “test drive” (e.g., predetermined period and/or set of requirements for data collection at a mobile device of the driver)—or other initiation of data collection occurs through inputs from the driver (e.g., consent and/or permission, activity, etc.) detected at (e.g., received at) an intermediate entity application (e.g., application already downloaded on the driver's mobile device, application commonly and/or frequently used by the driver, application commonly found on a majority of drivers' mobile devices, financial and/or financial monitoring application, application for non-vehicular insurance, banking application, etc.), wherein an SDK of the system 100 interfaces with the intermediate entity application and optionally with any other applications (e.g., end entity application, other applications, etc.) on a user device of the driver. The SDK can further interface, for instance, with a set of databases of the end entities, which specify criteria and/or requirements for data collection and/or processing, which can be utilized by the SDK in any or all of the method 200. The intermediate entity application is preferably further configured to provide information (e.g., a weblink, a re-direct to the insurance entity application and/or insurance entity website, details of a proposed offer, etc.) associated with one or more insurance entities, such as in response to an insurance entity accepting the driver's performance during a test drive and/or generating an offer to be provided to the driver.

In some variants, for instance, the method 200 (and/or any or all of its processes) is initiated by the user engaging with (e.g., providing a specific input at) an intermediate entity application, where an API of the intermediate entity application can be selectively in communication with an end entity application and/or the processors of the method.

For instance, any or all processing of the method can be performed with and/or at an SDK executing on the mobile user device, where the mobile user device hosts a set of applications, each of the set of applications associated with an application programming interface (API). These APIs can enable communication (e.g., selective communication in accordance with the method 200) between applications such that information can be provided to the user in various ways. For instance, an application associated with an intermediate entity can be used to direct that user to a second application (e.g., that they have not yet downloaded) or to a website associated with an end entity. Additionally or alternatively, any or all the processing of the method 200 can be distributed among multiple location, performed remotely (e.g., at a remote computing system associated with the SDK and/or APIs), and/or otherwise suitably performed.

Additionally or alternatively, the method 200 can be used in any number of different use cases (e.g., non-insurance use cases) and/or for use in performing any suitable functions.

### 4.1 Method—Collecting a Set of Data S100

The method 200 can include collecting a set of data S100, which functions to receive information with which to perform any or all processes of the method 200.

S100 is preferably performed initially in the method 200 and for each driver being assessed, but can additionally or alternatively be performed at any other time(s) and/or for any other users or combination of users.

The data preferably includes sensor data, and further preferably sensor data collected at a set of sensors onboard one or more user devices associated with each of the set of drivers, such as any or all of the sensor data described above (e.g., motion data from a set of motion sensors, accelerometer data, gyroscope data, location [e.g., GPS] data, audio data, video data, etc.). Additionally or alternatively, sensor data can be collected from sensors offboard a user device, from a combination of devices and/or data sources, and/or any other sources.

Additionally or alternatively, supplementary data associated with the driver (e.g., demographic information, survey and/or questionnaire data, inputs from the driver received at one or more applications, etc.), supplementary data associated with an end entity (e.g., eligibility criteria, etc.), supplementary data associated with an intermediate entity (e.g., permissions notification received from a driver), supplementary data associated with an environment of the driver (e.g., traffic conditions at their location, weather conditions at their location, etc.), information received from the user (e.g., via an intermediate entity application, via an end entity application, etc.), and/or any other data.

Any or all of the data can optionally be collected through one or more applications, such as, but not limited to: an intermediate entity application, an end entity application, other applications, and/or any combination. Additionally or alternatively, any or all of the data can be collected through an SDK, from remote computing subsystems, from databases and/or data storage, and/or any other locations.

S100 can optionally be performed in accordance with (e.g., during) a predetermined and/or dynamically determined time period, such as a test drive period (e.g., as described above), wherein the test drive period refers to a timeframe and/or time duration and/or eligibility (e.g., distance traveled) requirements for which data (e.g., sensor data) is collected and used to determine one or more actions (e.g., as described below). The test drive period can optionally be determined based on retrieving a set of eligibility criteria from the set of end entities, wherein the eligibility criteria can specify, for instance, any or all of: a number of days (e.g., total days, number of days in which the driver engages in driving, etc.) for the test drive period, a number of driving trips taken by the driver, a number of miles driven by the driver, a number and/or type of driving conditions (e.g., weather conditions, traffic conditions, nighttime conditions, etc.) experienced by the driver, and/or any other criteria.

In some variants, a set of features (e.g., as described below) are predicted and utilized to determine which of a set of end entity qualifications (e.g., eligibility criteria to be considered, satisfaction criteria to receive an offer, etc.) a user is most likely to qualify for, wherein the data is collected (e.g., at a sampling frequency, predetermined set of intervals, etc.) according to criteria associated with that end entity. Alternatively, a most rigorous set of criteria can be utilized and/or any other collection criteria can be used.

In a set of demonstrative examples, for instance, test drive periods can be specified through eligibility criteria as: a total number of days (e.g., 30 days, 40 days, between 5 and 50 days, less than 5 days, etc.) after the driver provides a permission for data collection, a total number of days the driver drives (e.g., 5 days of driving with at least 10 driving trips, 10 days of driving with at least 1 driving trip per day, 20 days of driving with at least 1 driving trip per day, at least 10 days of driving within a 30 day period, at least 2 weeks of driving where the driver goes no more than 2 days without driving, etc.), a total driving distance (e.g., 50 driving miles, 100 driving miles, 150 driving miles, between 20-200 driving miles, etc.), driving condition requirements (e.g., at least 1 trip taken at night), any combination of requirements, and/or any other requirements.

S100 can optionally include filtering out data and/or trips in which it is determined and/or suspected that the driver is not driving (e.g., trips where the user is determined to be the passenger, trips where the user is determined to be on public transportation and/or non-automobile transportation, etc.). In specific examples, for instance, a user can be identified as a driver (or not a driver) based on any or all of the processes as described in any or all of: U.S. application Ser. No. 15/401,761, filed 9 Jan. 2017, and U.S. application Ser. No. 16/022,184, filed 28 Jun. 2018, each of which is incorporated herein in its entirety by this reference.

S100 can optionally be iteratively repeated, wherein, for instance, a first set of data is used in S150 and a second set of data (e.g., separate and distinct from the 1^{st} set, overlapping with the 1^{st} set, taken at a later set of times than the 1^{st} set, etc.) is used in S200. Additionally or alternatively, S100 can be repeated at predetermined intervals (e.g., according to a predetermined frequency), at random intervals, in response to the initiation of a trip being detected, and/or at any other times.

S100 can optionally additionally include transmitting (e.g., selectively transmitting) any or all of the set of data, such as to another computer and/or processing system (e.g., remote computing system, cloud computing system, etc.), for processing.

In some variants, for instance, in which a 3^{rd} party (e.g., end entity) performs risk score and/or collision propensity and/or other driving analysis determinations, raw sensor data (and/or pre-processed, formatted, and/or otherwise processed sensor data) (e.g., sensor data from all the trips during the test drive period) is transmitted to the end entity (e.g., upon collection, once eligibility criteria are satisfied or predicted to be satisfied, once the test drive period has ended, etc.). In some examples, for instance, the data can be formatted or otherwise pre-processed based on requirements (e.g., retrieved from a lookup table) of the end entity models and/or algorithms prior to transmission.

Additionally or alternatively, S100 can include any other suitable processes.

### 4.2 Method—Analyzing the Set of Data to Determine a Set of Features S150

The method 200 can optionally include analyzing the set of data to determine a set of features S150 associated with the user (equivalently referred to herein as a driver) and/or user's mobile device, wherein the set of features can function to: inform processing of the data in S200; inform which entities data is shared with; inform which models are used to process the data; increase an efficiency of processing user data (e.g., by assigning the user to a similar subgroup); and/or confer any other benefits. Additionally or alternatively, S150 can function to trigger a set of actions (e.g., automatically enable a communicable link between an end entity and an intermediate entity, automatically enable a communicable link between an SDK and an end entity for the 1^{st} and/or 2^{nd} sets of data to be transmitted to the end entity, etc.) and/or perform any other functions.

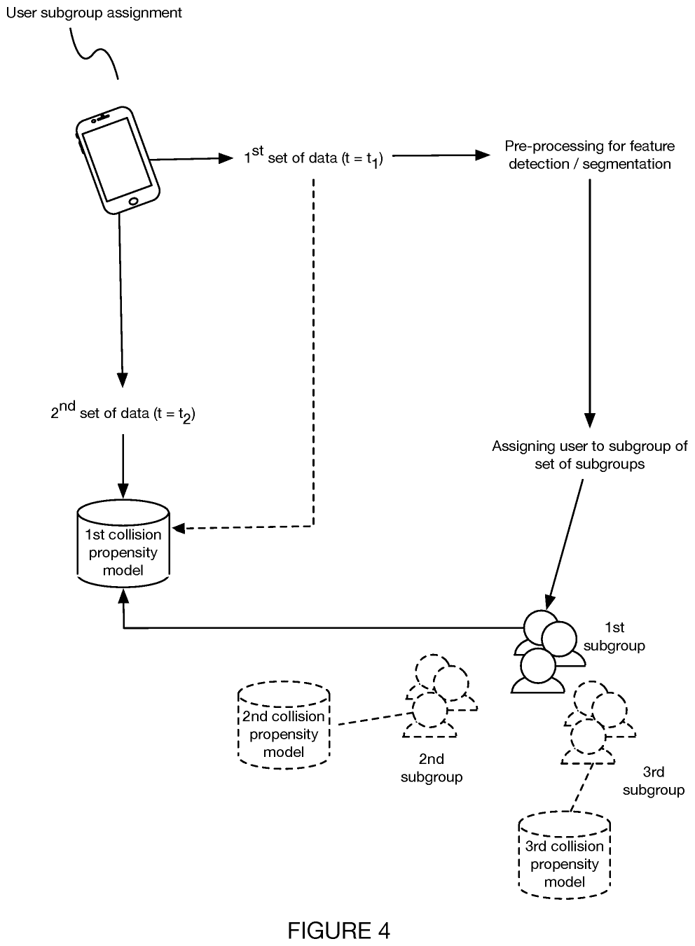

S150 is preferably performed in response to S100 (e.g., an initial set of iterations of S100, data collected during a 1^{st} time period in S100, etc.), but can additionally or alternatively be performed during S100, at another time during the method 200, at multiple times during the method 200. In some variants, S150 functions as a pre-processing process to inform any or all of the remaining processes of the method 200. In examples, for instance, S150 enables a user to be assigned to a particular subgroup of a plurality of subgroups (e.g., as shown in FIG. 4), where this assignment functions as an initial decision-making process to inform subsequent actions (e.g., to which end entity the user's data is sent to, which end entity is able to establish communication with the user [e.g., via an intermediate entity], which intermediate entity is able to provide information to the user, etc.], etc.) of the method 200. Additionally or alternatively, a subgroup assignment can function to increase an efficiency of processing the user's information (e.g., by processing the user's data with a particular, relevant set of models), increase an accuracy of the user's driving performance (e.g., by utilizing a model tailored to features of the user), and/or can confer any other benefits.

In some variants, S150 is performed throughout (e.g., iteratively, continuously, at predetermined intervals, etc.) S200 where the features produced in S150 can function to direct and/or redirect the specific models used to process the user's data and/or revise how the user's data gets processed.

The set of features are preferably determined (e.g., calculated, predicted, etc.) based on at least a portion of the set of data collected in S100, but can additionally or alternatively be calculated based on information from a set of APIs, demographic information, environmental information (e.g., retrieved based on a user's location), historical information (e.g., previously collected data for the user), and/or any other information.

In addition or alternative to those described above, the set of features can include, but is not limited to, any or all of: a low mileage characterization of the user, a high mileage characterization of the user (e.g., travels more than a predetermined number of trips in a particular time duration, travels more than a predetermined number of miles in a particular time duration, etc.); whether or not the user participates as a rideshare driver (e.g., to exclude that user's data from being used in further processing, to direct that user's data to a particular set of models and/or end entities); how diverse and/or risky the routes are that the user normally traverses; which types of behavioral patterns the user displays while driving; and/or any other features. The set of features can additionally or alternatively include a set of predicted metrics associated with the user's engagement in any or all of: continuing to provide data (e.g., enabling permissions to send data), continuing to drive during a test drive period, satisfying eligibility criteria, and/or any other metrics. For instance, the set of features can include: a predicted likelihood that the user's driver analysis will satisfy a set of criteria (e.g., exceed a safety threshold) associated with a set of end entities (e.g., wherein the end entities engage with the user if these criteria are satisfied); a predicted likelihood that the user will engage with information transmitted to them (e.g., a clickable link at a graphical user interface of the user device); a predicted likelihood that the user will not drop out (e.g., churn, abandon, prematurely end, etc.) of the test driver period; a predicted attrition rate and/or attrition time of the user; a predicted click rate of the user at one or more applications; and/or any other metrics.

The set of intermediate features are preferably calculated with a set of trained machine learning models (e.g., deep learning models, neural networks, etc.), but can additionally or alternatively be determined with a mathematical (e.g., statistical) and/or rule-based model, a set of decision logic, a decision tree, a lookup table, and/or any other tools.

In a set of examples, for instance, a trained machine learning model can be used to analyze raw GPS sensor data from the user device, fit it to a set of potential route options, look at a set of risk metrics assigned to the road segments composing those routes, examine how frequently the user traverses those routes, and based on all of this, determine any or all of: how many trips the user takes per day, how many miles the user travels per day, what his or her predicted monthly and/or annual mileage is, what his or her anticipated level of risk is based on the level of risk associated with these routes, and/or any other information that can function to segment the user into a particular subgroup to inform further processing.

In a set of examples, for instance, S150 can include predicting whether or not the user will continue to engage with information provided at their mobile user device during an entirety of the test driver period. This prediction can be determined with a predictive trained model (e.g., based on historical information associated with the user, based on mobile device usage activity collected during an initial portion of the test drive period, etc.), with a set of rules (e.g., detecting that the user has become inactive at his or her device and/or at a particular application such as that associated with an intermediate entity for at least a predetermined amount of time), and/or with any combination of tools. In a particular specific example, upon detecting that the user is likely to not complete requirements of the test drive period, his or her data can be assigned to a new set of models (e.g., those with lower temporal requirements), not further collected, directed to a different end entity, and/or otherwise used.

S150 can optionally include assigning a user (e.g., an identifier associated with his or her mobile user device) to a subgroup of a set of multiple user subgroups based on any or all of the set of features, wherein this subgroup assignment can be used to: direct the user's data to a particular set of models; prioritize an order in which models are evaluated; prioritize which end entity will be provided (and/or in which order) access to establishing a communicable link with the user, and/or any other outcomes.

In some examples, for instance, a first set of feature detection models are run to determine that the driver is a low mileage drive, wherein this assignment of the user to a low mileage subgroup is used to determine which models are used for further processing and/or which end entity is able to establish communication with the user's mobile device (e.g., via an intermediate entity application).

The matching of the user with a set of models and/or end entities can be accomplished with a lookup table, additional set of models, rule-based logic, and/or any other tools.

In some examples, for instance, a first end entity has prioritized (e.g., dynamically, in a predetermined fashion, etc.) receiving data from low mileage users, where a characterization of a user as being low mileage can optionally (e.g., when taking into account other factors) result in the low mileage user's data being send to that first end entity.

In other examples, if it is predicted that a user will not meet eligibility criteria associated with one or more sets of models associated with end entities, the existing data of the user can optionally still be processed (e.g., by the SDK), by an intermediate entity, or other models to determine a risk score or set of features, which can then be used to provide information other than that from an end entity to the user (e.g., an offer from an intermediate entity, a link at an intermediate entity application, etc.). In a particular demonstrative example, for instance, if it is predicted that a user will not qualify for an offer (e.g., insurance discount) from a particular end entity (e.g., based on a set of eligibility criteria associated with models assigned to the end entity), a consolation offer (e.g., from a different end entity, from an intermediate entity, from a different 3^{rd} party entity, etc.) can be provided through a selectively enabled communicable link to the user.

Additionally or alternatively, the test drive period can be prematurely and/or automatically ended (e.g., with the user notified via an application and/or the halting of further data collection initiated).

In a set of variants, S150 can include dynamically adjusting how data gets processed during the method, through the iterative (e.g., continuous, at a predetermined frequency, at multiple times during the method, etc.) prediction of a set of metrics and/or the comparison of collected data (or metrics determined based on the data) with a set of thresholds and/or satisfaction criteria. For instance, the specific models that are used to process the data and/or which end entity is able to access the data is dynamically determined and/or adjusted as time progresses (e.g., during a test drive period) based on any or all of: user behavior, activity at the mobile user device, driving behavior, supplementary data, and/or any other information. In a set of examples, for instance, the user's activity at the mobile user device and/or the dynamic properties of the mobile user device (e.g., number of times that the user logs in to an intermediate entity application, amount of time that the mobile user device is moving in a way characteristic of being in a vehicle, etc.) can be used to predict any or all of: whether or not the user will complete a test drive period, whether or not the user will meet eligibility criteria of a set of models, whether or not the user will meet satisfaction criteria of an end entity (e.g., has a collision propensity score below a predetermined threshold, has a predicted risk of collision below a predetermined threshold, engages in driving behaviors characterized as risk at less than a predetermined frequency, drives less than a predetermined number of miles on a weekly basis, etc.), and/or any other metrics which models should ultimately be processed with the data and/or which end entity should receive permissions to provide information to the user (e.g., first, at all, etc.). In a particular specific example, a first end entity can be preliminarily assigned to data collected from a mobile user device—however, if it is predicted that the user will not meet eligibility and/or satisfaction criteria for that first end entity, a second end entity (e.g., with different eligibility requirements, with a lower volume of data required for processing, etc.) can be assigned to the data.

Additionally or alternatively, S150 can include any other processes.

### 4.3 Method—Analyzing the Set of Data to Produce a Set of Driver Analysis Outputs S200

The method 200 preferably includes analyzing the set of data to produce a set of driver analysis outputs (equivalently referred to herein as driver risk outputs) S200, which functions to determine (e.g., calculate) a set of metrics reflective of a driving performance of the driver, which are subsequently used to perform and/or inform any or all of the remaining processes of the method 200. Additionally or alternatively, S200 can be used for other functions, analyzing the set of data can result in other outputs, and/or the method 200 can be otherwise suitably performed. Further additionally or alternatively, the method 200 can be performed in absence of S200.

S200 preferably includes processing at least a set of sensor data (e.g., collected over a test drive period), and optionally any supplementary data or other data (e.g., set of features), with a set of models (e.g., as described above). Additionally or alternatively, the sensor data can be processed in accordance with any or all of the processes as described in any or all of: U.S. application Ser. No. 15/243,565, filed 22 Aug. 2016, U.S. application Ser. No. 15/835,284, filed 7 Dec. 2017, and U.S. application Ser. No. 16/201,955, filed 27 Nov. 2018, each of which is incorporated herein in its entirety by this reference.

The set of driver risk outputs preferably includes a score and/or ranking and/or categorization of the user's driving performance (e.g., as described above) and/or any derived outputs from these (e.g., whether or not the driver's score exceeds a predetermined threshold set by the end entity, whether or not the driver has qualified for an offer, etc.), but can additionally or alternatively include any other outputs.

In preferred variants, the driver analysis outputs include a collision propensity metric which reflects (e.g., determines, predicts, etc.) the likelihood that the user will be involved in a collision. Additionally or alternatively, the outputs can include: a prediction of when and/or in which situations (e.g., environments, routes, etc.) a user would be involved in a collision; a type of behavior exhibited by the user that would most likely result in a collision; a type of collision (e.g., fender bender, head on collision, etc.) and/or infraction (e.g., running a stop sign, running a red light, etc.) that a user might be involved in, the risk score (e.g., as described above), and/or any other outputs.

Additionally or alternatively, S200 can include any other processes.

### 4.3 Method—Triggering a Set of Actions Based on the Set of Driver Risk Outputs S300

The method 200 can include triggering a set of actions based on the set of driver risk outputs S300, which functions to facilitate one or more optimized outcomes associated with the driver and/or end entity. In variations involving end entities which are insurance providers, for instance, S300 can function to facilitate (e.g., automatically facilitate) the matching of a driver with an optimal insurance provider and/or insurance offer (and/or their associated models), facilitate the matching of an end entity (e.g., insurance provider) with a safest group of drivers, provide custom offers to users based on details of their driving performance, and/or can perform any other functions. Additionally or alternatively, S300 can perform any other functions and/or be used in any other use cases.

S300 is preferably performed in response to and based on S200, but can additionally or alternatively be performed in response to S150 and/or at any other suitable time(s).

In a preferred set of variations, any or all the actions in S300 are triggered at least partially automatically. Additionally or alternatively, any or all of the actions can be triggered with manual input, and/or any combination.

Examples of actions triggered in S300 can include, but are not limited to, any or all of: determining and/or prioritizing a set of end entities (e.g., to determine which end entity's offer to provide to the driver first); providing the set of driver risk outputs to any or all of the set of end entities (e.g., to see which end entities would like to recruit the driver); receiving a set of inputs from the set of end entities (e.g., acceptance of a recommended driver, an offer generated for a driver, etc.) and/or drivers (e.g., selection of an end entity and/or offer, acceptance of an offer, desire to enroll with a particular end entity, read receipt of a notification provided to the driver, etc.); evaluating the set of inputs; establishing communication between an end entity and an intermediate entity (e.g., via their applications, to facilitate communication between the driver and the intermediate entity, etc.); establishing communication (e.g., via an intermediate entity applications) between an intermediate entity and a driver (e.g., providing information associated with an end entity to the driver through an application associated with an intermediate entity); and/or any other actions.

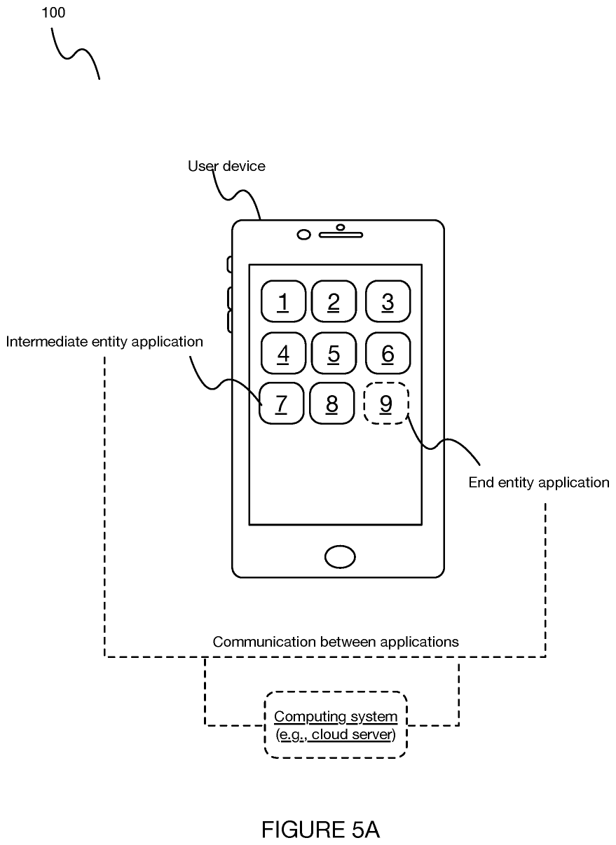

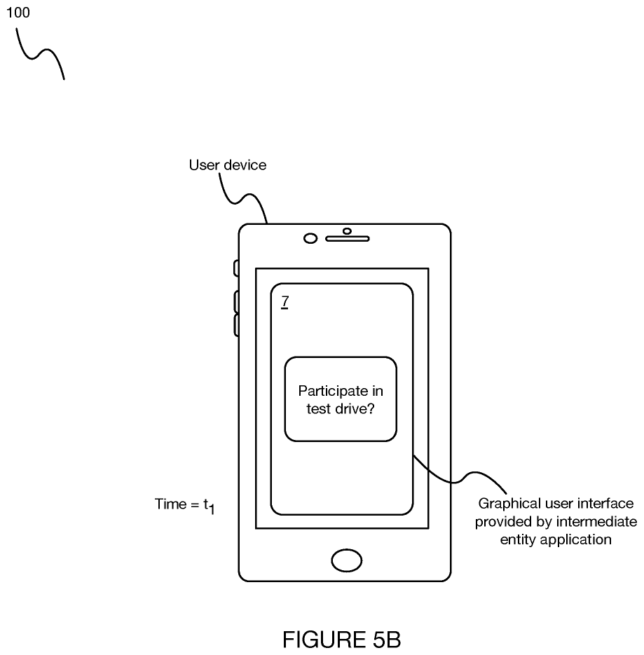

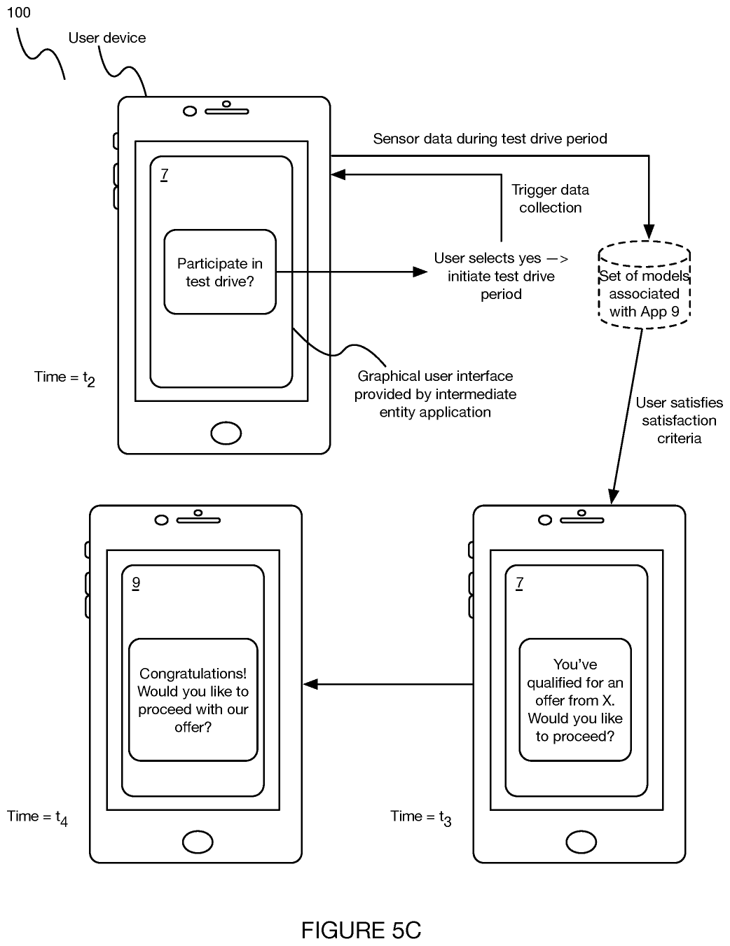

In some variants for instance, S300 includes automatically and selectively establishing communication (e.g., transmission of data, transmission of an alert, etc.) between entities (e.g., as shown in FIGS. 5A-5C) in response to a driver risk analysis and/or any intermediate outputs produced in the method 200. This can include establishing communication (e.g., via a communicable link, via the transmission of data, etc.) between any or all of: end entities, an end entity and an intermediate entity, an end entity and the user, an intermediate entity and the user, intermediate entities, and/or any other entities, individuals, and/or data sites. Entities can be in communication through the transmission of a communicable link to a user (e.g., from an intermediate entity application) that directs the user to an end entity application. Additionally or alternatively, communication can include the transmission of data between an SDK and an API, between APIs, between computing systems and/or processing systems, and/or in any other manner.

S300 can optionally include determining which end entity to contact (e.g., automatically contact, automatically transmit driver risk analysis scores to, etc.) first (e.g., for consideration in generating/transmitting an offer to the driver). This can be performed with any or all of: decision logic (e.g., rule-based logic, decision trees, etc.), a set of trained models and/or algorithms, database information, and/or any other tools. In some variations, for instance, any or all of the following information can be taken into account in determining a prioritized order of end entities: a conversion rate associated with the end entity (e.g., percentage of drivers which accept an offer from the end entity), parameters associated with an insurance entity's coverage (e.g., whether they provide coverage at locations associated if the driver), which insurance entity (if any) a driver is already engaged with (e.g., based on detecting at the SDK that the driver has an application already downloaded from a particular insurance entity), whether or not the end entity has predetermined exclusivity requirements (e.g., which prevents the driver from being presented another offer from another end entity within a predetermined time frame), and/or any other information.

S300 can optionally additionally or alternatively include providing driver risk outputs (e.g., produced in S200, encrypted driver data, etc.) to a set of one or more end entities (e.g., based on a prioritized order as described above).

S300 can optionally additionally or alternatively include determining (e.g., calculating, determining with a trained model, referencing a lookup table, etc.) a custom offer or other custom information to provide to a driver based on the driver's risk analysis and/or any associated parameters (e.g., decreasing an insurance cost for drivers which are deemed to be safe drivers, scaling down an insurance cost for drivers which is commensurate with his or her particular driving score, etc.).

S300 can optionally additionally or alternatively include contacting (e.g., transmitting a notification to) one or more drivers, which can function to facilitate their receipt of an offer or other information from an end entity. Contacting the driver is preferably done through a notification and/or alert (e.g., transmission of a link that directs him to an end entity website and/or application) provided at an intermediate entity application, but can additionally or alternatively be done independently of an intermediate entity application, at an end entity application, and/or through any other interfaces. In a set of examples, for instance, in response to an end entity generating information (e.g., an insurance offer and/or insurance quote) to be provided to a driver, an intermediate entity application can present a notification associated with the information at the intermediate entity application, wherein opening of the notification of the driver triggers a re-direct of the driver to an end entity application and/or website.

Additionally, any or all of the driver's actions and/or engagement levels at an application can be tracked and used in refining which end entities and/or offers to present to drivers and/or in which order to present them. For instance, in response to tracking engagement of the driver with information associated with an end entity presented at an intermediate entity application and/or with an end entity application after re-direct (e.g., whether or not the user landed on the end entity webpage, the amount of time that the user spent at the end entity application, whether or not the user engaged with an offer from the end entity, whether or not the user downloaded an end entity application, etc.), the end entities associated with highest engagement from users can be higher prioritized in recommendations made to future users.

Any or all of the actions triggered in S300 can optionally be determined based on any or all of: driver features (e.g., age, state/location, sex, etc.) such as those which are predicted to and/or have been determined to influence which end entity the user is most likely to engage with, whether or not the user has already engaged with and/or potentially engaged with (e.g., based on detecting with the SDK that the user has already downloaded an application for a particular end entity) an end entity, exclusivity rules and/or criteria associated with end entities, and/or any other information.

An action triggered in S300 can optionally include monitoring for enrollment and dropped enrollment of the driver during a test driver period, and optionally triggering a notification or other alert to the driver (e.g., through the intermediate entity application) in an event that a dropped enrollment is detected (e.g., to confirm that it is an advertent drop, to provide an option to re-enroll, etc.). Additionally or alternatively, one or more actions triggered in S300 can be configured to encourage engagement of the users and/or prevent dropped enrollment in a test drive, such as through the provision of information to the users (e.g., through the intermediate entity application)—examples of this information include, for instance, a tracking of their status and/or progression through the test drive, a graphic which indicates how much time and/or miles are left in the test drive, and/or any other information.

An action can additionally or alternatively include rendering and/or adjusting one or more graphical displays at a mobile user device (e.g., via an intermediate entity application, via an end entity application, etc.), wherein the graphical displays can provide any or all of: information to the user, input options to the user, a link that redirects the user to another application, an alert and/or notification, and/or any other information.

In some variants, actions are triggered based on any or all of the features described in S150. For instance, upon determining that the user is predicted to not complete a test drive period, a notification can be automatically sent to the user to incentivize and/or remind him or her to finish the test drive (e.g., complete trips, engage with the intermediate entity application, etc.).

In some variants, one or more actions can include adjusting parameters and/or how data is received, processed, and/or transmitted at the mobile user device. For instance, upon determining that the user's data will be processed by a certain set of models and/or is predicted to be able to be processed by a certain set of models, a sampling rate associated with data collection can be adjusted (e.g., increased to enable processing by models having rigorous eligibility criteria, decreased if it is predicted that the user will not be eligible for processing by certain models, etc.). Additionally or alternatively, any other parameters (e.g., power consumption, types of data collected, subset of sensors used to collect data, etc.) can be adjusted.

Additionally or alternatively, S300 can include any other suitable processes.

4.4 Method—Determining and/or Assessing Eligibility Criteria Associated with a Set of End Entities S400

The method 200 can optionally include determining (e.g., receiving, retrieving, etc.) and/or assessing eligibility criteria associated with one or more end entities, which can function to inform the performance and/or processing of any or all of the method 200. Additionally or alternatively, S400 can function to inform the prioritization of end entity offers, inform what data (e.g., type, amount, etc.) is collected in S100, inform how data is collected (e.g., at which set of time intervals, according to what sampling frequency, etc.), inform which actions are triggered in S300, and/or perform any other functions. Additionally or alternatively, the eligibility criteria can function to halt performance and/or further performance of the method 200 (e.g., for a particular driver, for a particular driver with respect to a particular end entity, etc.).

S400 can be performed at any suitable times prior to, during (e.g., during any or all of S100, S200, S300, etc.), and/or after the method 200.

The eligibility criteria preferably include criteria which specify eligibility requirements for the driver and/or data in order to trigger one or more actions in S300. These can include, for instance, any or all of: inclusion criteria, exclusion criteria, any combination, and/or any other criteria.

The eligibility criteria are preferably associated with (e.g., received from, retrieved from a database associated with, etc.) an end entity, but can additionally or alternatively be associated with a particular driver and/or group (e.g., demographic group, location-based group, etc.) of drivers, a location and/or region, and/or any other features. In a preferred set of variations, for instance, each of a set of end entities is associated with a particular set (e.g., unique set) of eligibility criteria. Additionally or alternatively, the eligibility criteria can include criteria generic to the method 200, any specific set of models and/or algorithms, and/or can be otherwise configured.

In some variants, for instance, an initial set of eligibility criteria is retrieved based on requirements of a set of models that are planned to be used (and/or available to be used) for processing of the user's data. These can include, for instance, verifying that a user's location (e.g., based on collected GPS coordinates, based on user input, etc.) is within a predetermined range that the models apply to. As the method progresses, additional eligibility criteria can be considered based on the sensor data being collected, such as the set of features as described in S150, and/or any other information.

In a first set of examples, the eligibility criteria associated with each of a set of end entities are utilized in S100 and/or prior to S100 to inform the types of data to be collected in S100 and/or the ways in which data is collected in S100. For instance, the eligibility criteria can specify any or all of: an amount of data (e.g., number of miles, number of days, etc.) required to be collected for further analysis in the method 200; the types of data (e.g., types of sensor data) required to be collected; required features of the data and/or its collection (e.g., number of continuous adjacent days during which data is collected, number of total days data is collected, number of total driving trips the user and mobile user device take part in, number of variety of locations at which data is collected, types of roadways on which data is collected, types of traffic conditions during which data is collected, types of weather conditions during which data is collected, etc.); how frequently data is collected (e.g., at what sampling frequency, once per second, etc.); and/or any other criteria.

The eligibility criteria can optionally additionally or alternatively be used to pre-process and/or format any or all of the data in S100 (e.g., to format data differently for different end entities based on different data requirements, to format data specifically for end-entity-specific models and/or algorithms, etc.).

In a second set of examples, additional or alternative to the first, the eligibility criteria are used in S200 to inform the processing of data with the set of models and/or algorithms, and/or to inform the type of outputs produced by the models.

For instance, the eligibility criteria can optionally specify which driving features (e.g., hard braking, aggressive acceleration, distracted driving, phone usage while driving, etc.) the end entity cares to know about, what thresholds and/or criteria make a driving feature qualify as risky (e.g., what sensor values qualify as a hard braking event), what fraction (e.g., percentage, decile, etc.) of drivers should be considered to be the “most safe”, in what number of groupings (e.g., types/levels of riskiness) should drivers be categorized, and/or any other information. In a particular demonstrative example, for instance, the eligibility criteria can specify that the most unsafe category of driver should be approximately n times as likely (e.g., 2, 3, 4, 5, 10, etc.) to have a collision as compared with an average driver in the remaining categories of drivers.

In a third set of examples, additional or alternative to those above, the eligibility criteria are used to specify which actions are triggered in S300 and/or the ways in which actions are triggered in S300.

### 4.5 Method: Additional Processes

The method 200 can additionally or alternatively include any other processes performed in any suitable order. For instance, the method 200 can include training (e.g., with supervised learning, with unsupervised learning, with semi-supervised learning, etc.) any or all of the set of models, re-training (e.g., updating, tuning, etc.) any or all of the set of models, and/or any other processes. Models can be re-trained, for instance, in response to any or all of: determining whether or not the user has satisfied eligibility criteria, determining whether or not the user has satisfied satisfaction criteria needed to qualify for matching/information (e.g., an offer) from an end entity, determining whether or not the user engages with information (e.g., clicks a link, downloads an end entity application, etc.), determining whether or not the user is involved in a collision, and/or any other information. The re-training can function to increase a predictive accuracy of the models, facilitate better matching between users and end entities (e.g., only matching users that have a high likelihood of accepting an offer), and/or any can confer any other benefits.

### 5. Variants

In a first variant, the method can include any or all of: during a 1^{st} time period, collecting a 1^{st} set of data at a mobile user device of the user; with a 1^{st} set of trained models, predicting a set of user features based on the 1^{st} set of data (e.g., a future mileage of travel of the mobile user device being below a threshold, the user participating as a driver in a ride share use case, etc.); assigning the mobile user device to a subgroup of a set of multiple subgroups based on the predicted set of user features; selecting a set of eligibility criteria for the mobile user device based on the assigned subgroup; initiating a commencement of a 2^{nd} time period separate and distinct from the 1^{st} time period, a duration of the 2^{nd} time period determined at least in part on the assigned subgroup, wherein initiating the 2^{nd} time period comprises collecting a 2^{nd} set of data at the mobile user device during the 2^{nd} time period; checking for satisfaction of the set of eligibility criteria based on at least a portion of the 2^{nd} set of data; selecting a 2^{nd} set of trained models (e.g., collision propensity algorithm associated with a 1^{st} end entity) from a plurality of trained models based on checking for satisfaction of the set of eligibility criteria; evaluating the 2^{nd} set of trained models with the 2^{nd} set of data to produce a set of outputs; comparing the set of outputs with a set of satisfaction criteria (e.g., collision propensity thresholds); in response to determining that the set of outputs does not satisfy the set of satisfaction criteria: evaluating the 2^{nd} set of data with a 3^{rd} set of trained models (e.g., collision propensity algorithm associated with a 2^{nd} end entity) to produce a risk score associated with the user; and based on a value of the risk score, selectively rendering a graphical display at an application executing on the mobile user device. Additionally or alternatively, the method can include any other processes.

In a second variant, the method can include any or all of: during a 1^{st} time period, collecting a 1^{st} set of data at a mobile user device associated with the user; predicting a set of features associated with the user based on the 1^{st} set of data; based on the set of features, selecting a 1^{st} set of trained models; selecting a duration of time (e.g., 20 days, 25 days, 30 days, between 1 and 30 days, between 1-50 trips, greater than 30 days, greater than 50 trips, any ranges encompassing these values, etc.) associated with a 2^{nd} time period, the 2^{nd} time period separate and distinct from the 1^{st} time period, based on the 1^{st} set of trained models; initiating a commencement of the 2^{nd} time period, comprising collecting a 2^{nd} set of data at the mobile user device during the 2^{nd} time period; retrieving a 1^{st} set of eligibility criteria based on the 1^{st} set of trained models; iteratively predicting a likelihood that the 1^{st} set of eligibility criteria will be satisfied during the 2^{nd} time period; in response to determining that the predicted likelihood falls below a predetermined threshold, selecting a 2^{nd} set of trained models associated with a 2^{nd} set of eligibility criteria, the 2^{nd} set of eligibility criteria separate and distinct from the 1^{st} set of eligibility criteria; adjusting the duration of the 2^{nd} time period based on the 2^{nd} set of eligibility criteria; evaluating the 2^{nd} set of trained models with the 2^{nd} set of data to produce the driver score in response to meeting the adjusted duration of the 2^{nd} time period; comparing the driver score with a set of satisfaction criteria; and in response to determining that the driver score satisfies the set of satisfaction criteria, automatically selectively rendering a graphical display at an application executing on the mobile user device. Additionally or alternatively, the method can include any other processes.

Although omitted for conciseness, the preferred embodiments include every combination and permutation of the various system components and the various method processes, wherein the method processes can be performed in any suitable order, sequentially or concurrently.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

Additional or alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for selectively providing information to a user in accordance with a driving score, the method comprising:
during a 1^{st} time period, collecting a 1^{st} set of data at a mobile user device of the user;
with a 1^{st} set of trained models, predicting a set of user features based on the 1^{st} set of data, the set of user features comprising:
a future mileage of travel of the mobile user device being below a threshold;
the user participating as a driver in a ride share use case;
assigning the mobile user device to a subgroup of a set of multiple subgroups based on the predicted set of user features;
selecting a set of eligibility criteria for the mobile user device based on the assigned subgroup;
initiating a commencement of a 2^{nd} time period separate and distinct from the 1^{st} time period, a duration of the 2^{nd} time period determined at least in part on the assigned subgroup, wherein initiating the 2^{nd} time period comprises collecting a 2^{nd} set of data at the mobile user device during the 2^{nd} time period;
checking for satisfaction of the set of eligibility criteria based on at least a portion of the 2^{nd} set of data;
selecting a 2^{nd} set of trained models from a plurality of trained models based on checking for satisfaction of the set of eligibility criteria;
evaluating the 2^{nd} set of trained models with the 2^{nd} set of data to produce a set of outputs;
comparing the set of outputs with a set of satisfaction criteria;
in response to determining that the set of outputs does not satisfy the set of satisfaction criteria:
evaluating the 2^{nd} set of data with a 3^{rd} set of trained models to produce a risk score associated with the user; and
based on a value of the risk score, selectively rendering a graphical display at an application executing on the mobile user device.

2. The method of claim 1, wherein the driving score is further determined based on the 1^{st} set of data.

3. The method of claim 1, wherein selecting the 2^{nd} set of trained models from the plurality of trained models further comprises calculating a completion prediction metric associated with the user, wherein the completion prediction metric is determined based on a predicted usage of the mobile user device during the duration.

4. The method of claim 3, wherein the completion prediction metric is calculated, at least in part, based on the 1^{st} set of data.

5. The method of claim 4, further comprising iteratively re-calculating the completion prediction metric during the 2^{nd} time period, wherein in an event that the completion prediction metric does not exceed a predetermined threshold, the method further comprises evaluating a 4^{th} set of trained models with the 2^{nd} set of data, the 4^{th} set of trained models having a second set of eligibility criteria separate and distinct from the first set of eligibility criteria.

6. The method of claim 4, wherein the completion prediction metric is calculated with a 5^{th} set of trained models.

7. The method of claim 1, wherein checking for the set of satisfaction criteria comprises checking that at least one of the following is satisfied during the duration of the 2^{nd} time period:
a number of miles traveled by the mobile user device while in a vehicle exceeds at least a first predetermined threshold; or
a number of trips completed by the mobile user device while in the vehicle exceeds at least a second predetermined threshold.

8. The method of claim 1, wherein in response to selecting the 2^{nd} set of trained models, automatically adjusting a sampling rate of data collection at the mobile user device.

9. The method of claim 1, further comprising retraining the 1^{st} set of models based on the 2^{nd} set of data.

10. The method of claim 1, further comprising receiving an input from the user at the application in response to rendering the graphical display and retraining the 1^{st} set of models based on the input.

11. The method of claim 1, wherein the set of user features further comprises a prediction of a set of routes the user will drive and a calculation of an average riskiness associated with the set of routes.

12. The method of claim 1, wherein the 2^{nd} set of trained models comprises a collision propensity algorithm configured to predict a likelihood that the user will experience a collision within a predetermined number of miles driven.

13. The method of claim 12, wherein the set of outputs is produced based on organizing the user into a group of a plurality of groups based the predicted likelihood, wherein the set of outputs reflects the group order relative to other groups in the plurality.

14. A method for selectively providing information to a user in accordance with a driver score, the method comprising:
during a 1^{st} time period, collecting a 1^{st} set of data at a mobile user device associated with the user;
predicting a set of features associated with the user based on the 1^{st} set of data;
based on the set of features, selecting a 1^{st} set of trained models;
selecting a duration of time associated with a 2^{nd} time period, the 2^{nd} time period separate and distinct from the 1^{st} time period, based on the 1^{st} set of trained models;
initiating a commencement of the 2^{nd} time period, comprising collecting a 2^{nd} set of data at the mobile user device during the 2^{nd} time period;
retrieving a 1^{st} set of eligibility criteria based on the 1^{st} set of trained models;
iteratively predicting a likelihood that the 1^{st} set of eligibility criteria will be satisfied during the 2^{nd} time period;
in response to determining that the predicted likelihood falls below a predetermined threshold, selecting a 2^{nd} set of trained models associated with a 2^{nd} set of eligibility criteria, the 2^{nd} set of eligibility criteria separate and distinct from the 1^{st} set of eligibility criteria;
adjusting the duration of the 2^{nd} time period based on the 2^{nd} set of eligibility criteria;
evaluating the 2^{nd} set of trained models with the 2^{nd} set of data to produce the driver score in response to meeting the adjusted duration of the 2^{nd} time period;
comparing the driver score with a set of satisfaction criteria;
in response to determining that the driver score satisfies the set of satisfaction criteria, automatically selectively rendering a graphical display at an application executing on the mobile user device.

15. The method of claim 14, wherein in response to determining that the driver score does not satisfy the set of satisfaction criteria, selectively rendering a second graphical display at a second application executing on the mobile user device, the second application separate and distinct from the 1^{st} application.

16. The method of claim 14, wherein predicting the set of features is performed with a 3^{rd} set of trained models.

17. The method of claim 14, wherein the driver score comprises a collision propensity metric, wherein the collision propensity metric predicts a probability that the user will experience a collision within a predetermined number of future miles driven.

18. The method of claim 17, wherein the collision propensity metric is further determined based on risk metric, the risk metric separate and distinct from the collision propensity metric, wherein the risk metric is calculated with a 3^{rd} set of trained models.

19. The method of claim 14, wherein in response to determining that the user will not meet the 1^{st} set of eligibility criteria, selectively establishing communication the mobile user device and a 3^{rd} party application.

20. The method of claim 14, further comprising retraining the 2^{nd} set of trained models based on an input received from the user in response to selectively rendering the graphical display.
